(19) United States
(12) Patent Application Publication
(10) Pub. No.: US 2014/0000375 A1
(43) Pub. Date: Jan. 2, 2014

(54) PRESSURE SENSOR ASSEMBLY

(71) Applicants: Calin Victor Miclaus, Fremont, CA (US); Brian Allen Engle, Armada, MI (US); Chris Daniel Wagner, San Jose, CA (US); Dale Alan Gee, Los Gatos, CA (US)

(72) Inventors: Calin Victor Miclaus, Fremont, CA (US); Brian Allen Engle, Armada, MI (US); Chris Daniel Wagner, San Jose, CA (US); Dale Alan Gee, Los Gatos, CA (US)

(73) Assignee: General Electric Company, Schenectady, NY (US)

(21) Appl. No.: 13/538,146

(22) Filed: Jun. 29, 2012

(51) Int. Cl. G01L 7/00

(52) U.S. Cl. 73/706

(57) ABSTRACT

A pressure sensor assembly comprises a fluid channel having an inlet portion and an outlet portion, wherein the outlet portion is larger than the inlet portion.

### BACKGROUND OF THE INVENTION

The subject matter disclosed herein relates to a pressure sensor assembly for measuring the pressure of a fluid.

Pressure sensor assemblies can include a pressure sensing die mounted to a substrate that is retained by a package. In one configuration, the pressure sensing die is exposed to a fluid (e.g., liquid or gas) that travels through a channel in the package and/or substrate in order to determine the pressure of the fluid. In some assemblies, the pressure sensing die can crack or otherwise be damaged by energy transferred from the fluid to the die during spikes in pressure.

The discussion above is merely provided for general background information and is not intended to be used as an aid in determining the scope of the claimed subject matter.

### BRIEF DESCRIPTION OF THE INVENTION

A pressure sensor assembly comprises a fluid channel having an inlet portion and an outlet portion, wherein the outlet portion is larger than the inlet portion. An advantage that may be realized in the practice of some disclosed embodiments of the pressure sensor assembly is the reduction in cracking or damage of the pressure sensing die caused by energy transferred from the fluid to the die during spikes in pressure. The larger outlet portion of the fluid channel dissipates energy in the pressure wave and decreases the magnitude of its pressure.

In one embodiment, a pressure sensor assembly for measuring a pressure of a fluid is disclosed. The pressure sensor assembly comprises a sensor body, a sensor port coupled to the sensor body and to a source of the fluid, the sensor port comprising a sensor port fluid channel through which the fluid flows from the source of the fluid, a substrate located in a cavity formed between the sensor body and the sensor port, a pressure sensing die mounted to the substrate, and an attenuator coupled to the sensor port, wherein the attenuator comprises an attenuator fluid channel through which the fluid flows from the source of the fluid, the attenuator fluid channel comprising an inlet portion and an outlet portion, the size of the inlet portion is less than the size of the outlet portion, and wherein the sensor port and the attenuator are disposed to form a continuous fluid path through the attenuator fluid channel and the sensor port fluid channel.

In another embodiment, the pressure sensor assembly comprises a sensor body, a sensor port coupled to the sensor body and to a source of the fluid, the sensor port comprising a sensor port fluid channel through which the fluid flows from the source of the fluid, the sensor port fluid channel comprising a port inlet portion and a port outlet portion, wherein the size of the port inlet portion is less than the size of the port outlet portion, a substrate located in a cavity formed between the sensor body and the sensor port, a pressure sensing die mounted to the substrate, and an attenuator coupled to the sensor port, wherein the attenuator comprises an attenuator fluid channel through which the fluid flows from the source of the fluid, the attenuator fluid channel comprising an attenuator inlet portion and an attenuator outlet portion, the size of the attenuator inlet portion is less than the size of the attenuator outlet portion, and wherein the sensor port and the attenuator are disposed to form a continuous fluid path through the attenuator fluid channel and the sensor port fluid channel.

In yet another embodiment, the pressure sensor assembly comprises a sensor body, a sensor port coupled to the sensor body and to a source of the fluid, the sensor port comprising a sensor port fluid channel through which the fluid flows from the source of the fluid, the sensor port fluid channel comprising a port inlet portion and a port outlet portion, wherein the size of the port inlet portion is less than the size of the port outlet portion, a substrate located in a cavity, the cavity formed between the sensor body and the sensor port, and a pressure sensing die mounted to the substrate.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a cross-section of an exemplary pressure sensor assembly;

FIG. 2 is a bottom view of an exemplary gasket used in the pressure sensor assembly of FIG. 1;

FIG. 3 is a cross-section of another exemplary pressure sensor assembly;

FIG. 4 is a perspective view of the bottom side of the exemplary sensor body of FIG. 3;

FIG. 5 is a cross-section of another exemplary pressure sensor assembly with a tapered fluid channel;

FIG. 6 is a cross-section of another exemplary pressure sensor assembly with an attached pressure attenuator;

FIG. 7 is an exemplary pressure attenuator configuration; and

FIG. 8 is an exemplary pressure attenuator configuration.

### DETAILED DESCRIPTION OF THE INVENTION

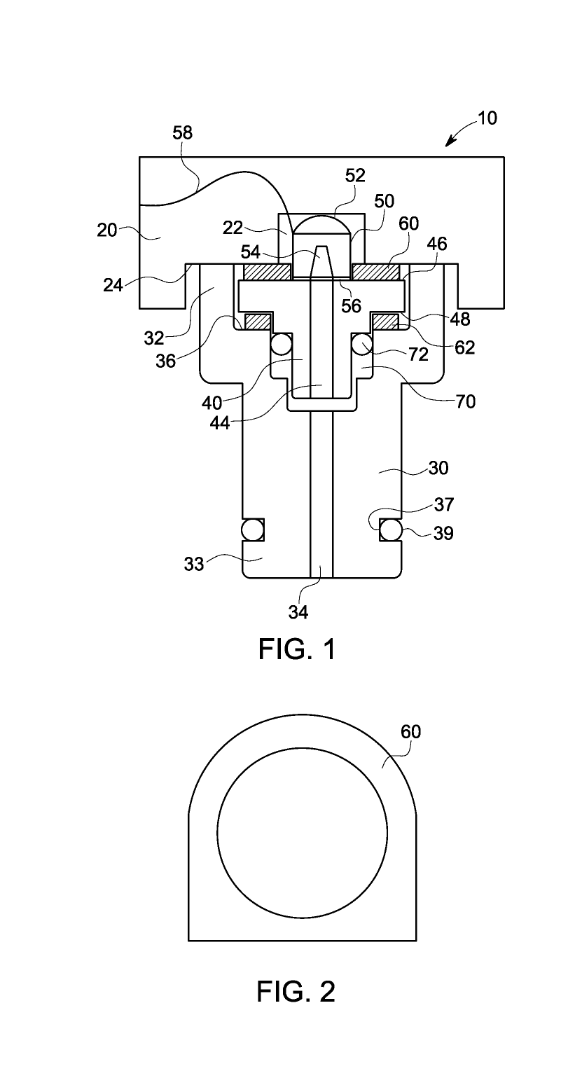

FIG. 1 is an exemplary pressure sensor assembly 10, which includes a sensor body 20 (or first member) coupled to a first end 32 of a sensor port 30 (or second member) that form the package for a substrate 40 to which a pressure sensing die 50 is mounted. The pressure sensing die 50 measures the pressure of a fluid (e.g., gas, liquid) that flows through the fluid channel 34 of the sensor port 30. The sensor port has a second end 33 coupled to the source of the fluid, then through the fluid channel 44 of the substrate 40, and then through the fluid channel 54 of the pressure sensing die 50, wherein the fluid channels 34, 44, 54 are aligned axially to allow a continuous fluid path. In the exemplary embodiment, the substrate 40 is a ceramic button. Although the exemplary embodiment employs a sensor body 20 and sensor port 30 enclosing the substrate 40, it will be understood that different members can be used to enclose the substrate 40.

The sensor body 20 can include a cavity 22 in which the pressure sensing die 50 is located. The pressure sensing die 50 can be mounted to the top side 46 of the substrate 40 using, e.g., a glass frit 56 to bond the pressure sensing die 50 onto the substrate 40. It will be understood that, in other embodiments, the pressure sensing die 50 can be mounted to the bottom side 48 of the substrate 40. It will be understood that the term “top side” as used herein refers to a side facing the sensor body 20, while the “bottom side” refers to a side facing the sensor port 30, regardless of the orientation of the pressure sensor assembly 10.

In one embodiment, the pressure sensing die 50 determines the pressure of the fluid to which the pressure sensing die 50 is exposed in the fluid channel 54 of the pressure sensing die 50. A gel cap 52 can be used to protect the electrical circuitry of the pressure sensing die 50 from the environment. In one embodiment, a silicon cap can be placed on the top of and integral to the pressure sensing die 50 that creates a vacuum chamber, where the reference vacuum is used for the pressure sensing die 50 to sense absolute pressure. Electrical leads 58 can connect the pressure sensing die 50 to monitoring equipment for reporting the pressure of the fluid.

The sensor port 30 can include a groove 37 in which an o-ring 39 can be placed to seal the connection with the source of the fluid flowing through the fluid channel 34 of the sensor port 30. The sensor port 30 forms a cavity 70 in which the substrate 40 is located. In another embodiment, the cavity 70 can be formed by the sensor body 20 or otherwise formed between the sensor body 20 and the sensor port 30. The substrate 40 is located in the cavity 70 such that the top side 46 of the substrate 40 faces the bottom side 24 of the sensor body 20 and the bottom side 48 of the substrate 40 faces the top side 36 of the sensor port 30. An o-ring 72 can be installed in the cavity 70 between the substrate 40 and the sensor port 30 to seal against the fluid flowing through pressure sensor assembly 10.

As shown in the exemplary pressure sensor assembly 10 of FIG. 1, a first gasket 60 or other energy absorbing member can be installed between the substrate 40 and the sensor body 20. In one embodiment, the first gasket 60 surrounds at least a portion of the pressure sensing die 50. This first gasket 60 decouples the top side 46 of the substrate 40 from the bottom side 24 of the sensor body 20, reducing the energy that can be transferred from the fluid, or from vibrations or shocks, to the pressure sensing die 50. For example, vibrations, shocks, or the pressure of the fluid flowing though the fluid channel 44 of the substrate 40 and the fluid channel 54 of the pressure sensing die 50 can cause the substrate 40 and pressure sensing die 50 to move towards and contact the sensor body 20. The first gasket 60 can absorb some of the energy caused by these events and reduce the amount of energy transferred to the pressure sensing die 50, thereby reducing the potential for cracking or damage to the pressure sensing die 50.

As shown in the exemplary pressure sensor assembly 10 of FIG. 1, a second gasket 62 or other energy absorbing member can be installed between the substrate 40 and the sensor port 30. In one embodiment, the second gasket 62 surrounds at least a portion of the substrate 40 and/or at least a portion of the fluid channels 34, 44, 54. The second gasket 62 decouples the bottom side 48 of the substrate 40 from the top side 36 of the sensor port 30, reducing the energy that can be transferred from the fluid, or from vibrations or shocks, to the pressure sensing die 50. For example, vibrations, shocks, or the pressure of the fluid flowing though the fluid channel 44 of the substrate 40 and the fluid channel 54 of the pressure sensing die 50 can cause the substrate 40 to move towards and contact the sensor port 30. The second gasket 62 can absorb some of the energy caused by these events and reduce the amount of energy transferred to the pressure sensing die 50, thereby reducing the potential for cracking or damage to the pressure sensing die 50.

FIG. 2 is an exemplary first gasket 60 used in the pressure sensor assembly 10 of FIG. 1. In this exemplary configuration, the first gasket 60 can be shaped to surround at least a portion of the pressure sensing die 50 mounted to the substrate 40. Although not shown, an exemplary second gasket 62 can be shaped to surround at least a portion of the substrate 40 and/or at least a portion of the fluid channels 34, 44, 54. The first gasket 60 and the second gasket 62 can have thicknesses, e.g., in the range of 0.010 in (0.254 mm) to 0.030 in. (0.762 mm). Exemplary thickness can include 0.015 in. (0.381 mm) and 0.020 in. (0.508 mm). It will be understood that the first gasket 60 and the second gasket 62 can have a number of different shapes and thicknesses. The first gasket 60 and the second gasket 62 can be made of an elastomeric material or other material that is compliant so as to absorb the energy of the fluid (or from e.g., the vibration or shock experienced by the pressure sensor assembly 10). Exemplary materials for the first gasket 60 and second gasket 62 can include, e.g., nitrile rubber, silicon rubber, or any other suitable elastomeric or other material. It will be understood that the first gasket 60 can be used with or without the second gasket 62, while the second gasket 62 can also be used with or without the first gasket 60.

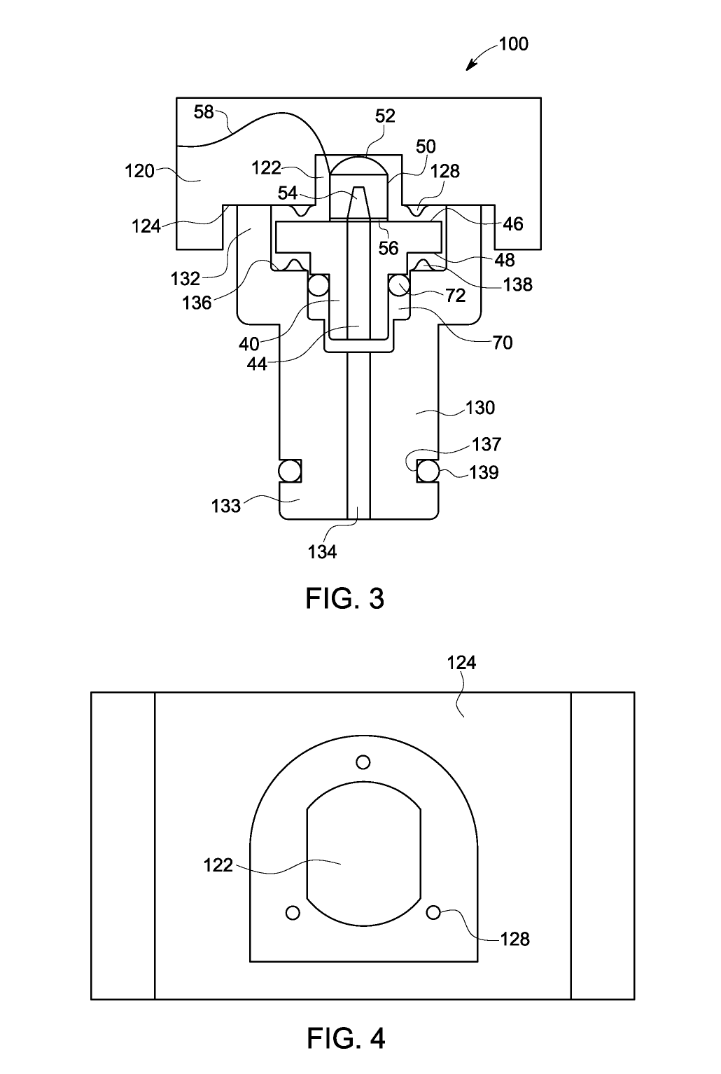

FIG. 3 is another exemplary pressure sensor assembly 100, which includes a sensor body 120 coupled to a first end 132 of a sensor port 130 that form the package for a substrate 40 to which a pressure sensing die 50 is mounted. The pressure assembly 100 of FIG. 3 shares several of the same components of the pressure sensor assembly of FIG. 1, except the structure used to decouple the substrate 40 from the sensor body 120 and the sensor port 130. While separate gaskets 60, 62 were used in the pressure sensor assembly 10 of FIG. 1, the pressure sensor assembly 100 of FIG. 3 employs features that are integrated into the sensor body 120 and sensor port 130.

The pressure sensing die 50 measures the pressure of a fluid (e.g., gas, liquid) that flows through the fluid channel 134 of the sensor port 130. The sensor port 130 has a second end 133 coupled to the source of the fluid, then through the fluid channel 44 of the substrate 40, and then through the fluid channel 54 of the pressure sensing die 50, wherein the fluid channels 134, 44, 54 are aligned axially to allow a continuous fluid path. In the exemplary embodiment, the substrate 40 is a ceramic button.

The sensor body 120 can include a cavity 122 in which the pressure sensing die 50 is located. The pressure sensing die 50 can be mounted to the top side 46 (or first side) of the substrate 40 using, e.g., a glass frit 56 to bond the pressure sensing die 50 onto the substrate 40. It will be understood that, in other embodiments, the pressure sensing die 50 can be mounted to the bottom side 48 of the substrate 40. It will be understood that the term “top side” as used herein refers to a side facing the sensor body 120, while the “bottom side” refers to a side facing the sensor port 130, regardless of the orientation of the pressure sensor assembly 100.

In one embodiment, the pressure sensing die 50 determines the pressure of the fluid to which the pressure sensing die 50 is exposed in the fluid channel 54 of the pressure sensing die 50. A gel cap 52 can be used to protect the electrical circuitry of the pressure sensing die 50 from the environment. In one embodiment, a silicon cap can be placed on the top of and integral to the pressure sensing die 50 that creates a vacuum chamber, where the reference vacuum is used for the pressure sensing die 50 to sense absolute pressure. Electrical leads 58 can connect the pressure sensing die 50 to monitoring equipment for reporting the pressure of the fluid.

The sensor port 130 can include a groove 137 in which an o-ring 139 can be placed to seal the connection with the source of the fluid flowing through the fluid channel 134 of the sensor port 130. The sensor port 130 forms a cavity 70 in which the substrate 40 is located. In another embodiment, the cavity 70 can be formed by the sensor body 120 or otherwise formed between the sensor body 120 and the sensor port 130. The substrate 40 is located in the cavity 70 such that the top side 46 of the substrate 40 faces the bottom side 124 of the sensor body 120 and the bottom side 48 of the substrate 40 faces the top side 136 of the sensor port 130. An o-ring 72 can be installed in the cavity 70 between the substrate 40 and the sensor port 130 to seal against the fluid flowing through pressure sensor assembly 10.

As shown in the exemplary pressure sensor assembly 100 of FIG. 3, a first set of protrusions 128 extend from the bottom side 124 of the sensor body 120 toward the top side 46 of the substrate 40. In one embodiment, the first set of protrusions 128 surround at least a portion of the pressure sensing die 50. The first set of protrusions 128 decouple the top side 46 of the substrate 40 from the bottom side 124 of the sensor body 120, reducing the energy that can be transferred from the fluid, or from vibrations or shocks, to the pressure sensing die 50. For example, vibrations, shocks, or the pressure of the fluid flowing though the fluid channel 44 of the substrate 40 and the fluid channel 54 of the pressure sensing die 50 can cause the substrate 40 and pressure sensing die 50 to move towards and contact the sensor body 120. The first set of protrusions 128 can absorb some of the energy caused by these events and reduce the amount of energy transferred to the pressure sensing die 50, thereby reducing the potential for cracking or damage to the pressure sensing die 50.

As shown in the exemplary pressure sensor assembly 100 of FIG. 3, a second set of protrusions 138 extend from the top side 136 of the sensor port 130 toward the bottom side 48 of the substrate 40. In one embodiment, the second set of protrusions 138 surround at least a portion of the substrate 40 and/or at least a portion of the fluid channels 134, 44, 54. The second set of protrusions 138 decouple the bottom side 48 of the substrate 40 from the top side 136 of the sensor port 130, reducing the energy that can be transferred from the fluid, or from vibrations or shocks, to the pressure sensing die 50. For example, vibrations, shocks, or the pressure of the fluid flowing though the fluid channel 44 of the substrate 40 and the fluid channel 54 of the pressure sensing die 50 can cause the substrate 40 to move towards and contact the sensor port 30. The second set of protrusions 138 can absorb some of the energy caused by these events and reduce the amount of energy transferred to the pressure sensing die 50, thereby reducing the potential for cracking or damage to the pressure sensing die 50.

FIG. 4 is a perspective view of the bottom side 124 of the exemplary sensor body 120 showing the first set of protrusions 128. In this exemplary configuration, the first set of protrusions 128 can be located to surround at least a portion of the pressure sensing die 50 mounted to the substrate 40. Although not shown in FIG. 4, an exemplary set of second protrusions 138 on the sensor port 130 can be located to surround at least a portion of the substrate 40. The first set of protrusions 128 and the second set of protrusions 138 can have a height in the range of, e.g., 0.005 in (0.127 mm) to 0.030 in. (0.762 mm). Exemplary heights include, e.g., 0.010 in (0.254 mm) and 0.015 in. (0.381 mm). It will be understood that the first set of protrusions 128 and the second set of protrusions 138 can have a number of different shapes (e.g., hemispherical, ring, half toroid, round ridge, ribs) and heights where the protrusions 128, 138 can deform a small amount.

In one embodiment, the first set of protrusions 128 and the second set of protrusions 138 can be molded as part of the sensor body 120 and sensor port 130, respectively. Exemplary plastic materials that can absorb the energy of the fluid (or from, e.g., the vibration or shock experienced by the pressure sensor assembly 100) for the sensor body 120 and sensor port 130 (and the first set of protrusions 128 and the second set of protrusions 138) can include, e.g., nylon or PBT. It will be understood that the first set of protrusions 128 can be used with or without the second set of protrusions 138, while the second set of protrusions 138 can also be used with or without the first set of protrusions 128.

In one embodiment, the material and height of the first set of protrusions 128 and the second set of protrusions 138 can be chosen such that the substrate 40 is coupled to the protrusions 128, 138 and therefore the sensor body 120 and sensor port 130 during manufacturing. However, afterwards, material creep can occur, causing the protrusions 128, 138 to deform and, e.g., lower in height, decoupling the substrate 40 from the sensor body 120 and the sensor port 130.

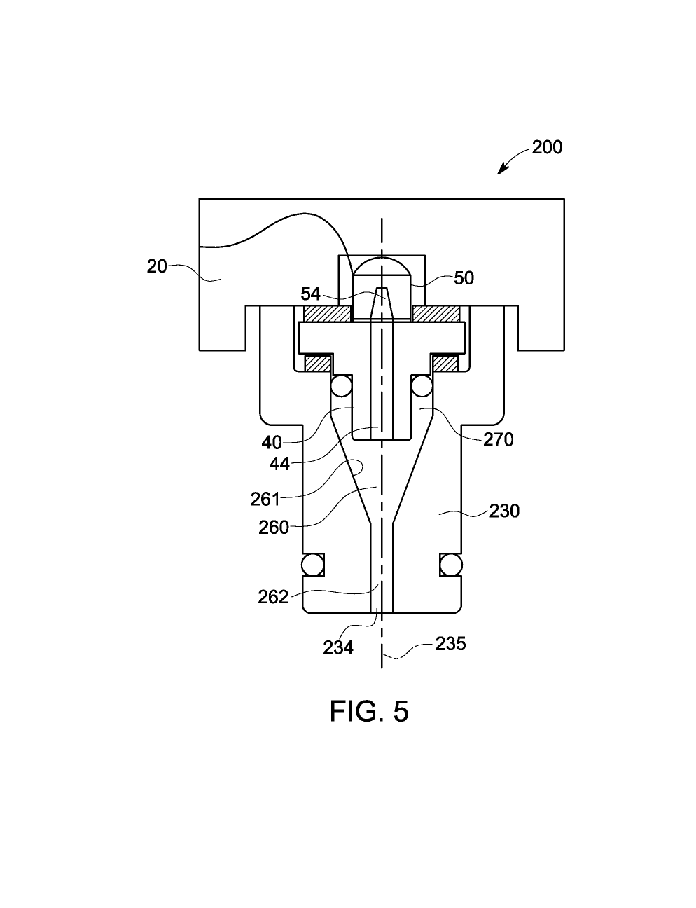

FIG. 5 is another exemplary pressure sensor assembly 200, which includes a sensor body 20 coupled to a sensor port 230 that form the package for a substrate 40 to which a pressure sensing die 50 is mounted. The pressure assembly 200 of FIG. 5 shares several of the same components of the pressure sensor assembly of FIG. 1, which, it is noted, operate in the same manner as described above with respect to FIG. 1, however, several reference numerals are removed from FIG. 5 for purposes of clarity in the figure. The exemplary pressure sensor assembly 200 comprises a tapered sensor port fluid channel 234 in the sensor port 230 that includes an inlet portion 262, and an outlet portion 260 that is larger in size (e.g., diameter, circumference, width, length, etc.) than the inlet portion 262 and which is integrally formed with cavity 270.

The pressure sensing die 50 measures the pressure of a fluid (e.g., gas, liquid) that flows through the sensor port fluid channel 234 of the sensor port 230, through the fluid channel 44 of the substrate 40, through the fluid channel 54 of the pressure sensing die 50, wherein the fluid channels 234, 44, 54 are aligned axially, as illustrated by the axis 235 of the sensor port fluid channel 234, and form a continuous fluid path. In one embodiment, the fluids channels assume a collinear alignment as shown in FIG. 5.

The sensor port fluid channel 234 comprises an inlet portion 262 and an outlet portion 260, designed as a pressure reduction feature. It should be understood that the tapered cross-section view of FIG. 5 depicts a conical shaped cavity 270 inside sensor port 230, having a sloped sidewall 261. The smaller inlet portion 262 of the sensor port fluid channel 234 faces toward the coupled source of the fluid. A pressure wave in the fluid entering the inlet portion 262 of the sensor port fluid channel 234 and traveling through the larger outlet portion 260 results in a decreased magnitude of the fluid pressure at the front of the wave. The pressure reduction is proportional to the area across the front of the wave. As the pressure wave travels toward the substrate 40 through the outlet portion 260 of the sensor port fluid channel 234, the wave front is distributed across an increasingly larger cross-sectional area of the sensor port fluid channel 234, which dissipates the energy of the pressure wave and decreases the magnitude of its pressure. Thus, the pressure wave intensity is gradually reduced as it passes through the outlet portion 260 toward the substrate fluid channel 44. The velocity of the pressure wave eventually reaching the pressure sensing element 50 is less than the pressure wave than would otherwise occur. The functionality of the pressure sensing element can be affected by pressure spikes impacting the sensor. By reducing the magnitude of pressure waves reaching the sensor, the risk of pressure sensor failure is reduced.

It should be understood that the tapered (conical) shape of the outlet portion 260 illustrated in FIG. 5 is an example of a pressure reduction feature of the sensor port fluid channel 234, and that the sensor port fluid channel 234 can assume other configurations for reducing the magnitude of a pressure wave. For example, the sidewalls off the sensor port fluid channel 234 can be curved, as in a circular or parabolic arc, or they can comprise steps or points disposed at various angles. All of these configurations should be considered within the scope of the appended claims.

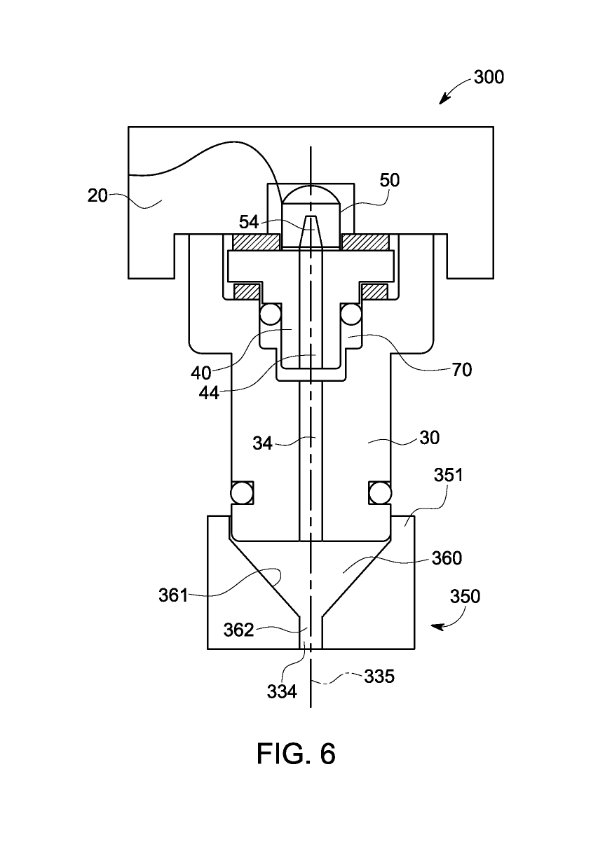

FIG. 6 is another exemplary pressure sensor assembly 300, which includes a sensor body 20 coupled to a sensor port 30 that form the package for a substrate 40 to which a pressure sensing die 50 is mounted. The pressure assembly 300 of FIG. 6 shares several of the same components of the pressure sensor assembly of FIG. 1, which, it is noted, operate in the same manner as described above with respect to FIG. 1, however, several reference numerals are removed from FIG. 6 for purposes of clarity in the figure. The exemplary pressure sensor assembly 300 comprises an attached attenuator 350 having a tapered attenuator fluid channel 334 that includes an inlet portion 362, and an outlet portion 360, that is larger in size than the inlet portion 362, and a rim 351, for attaching the attenuator 350 to sensor port 30.

The pressure sensing die 50 measures the pressure of a fluid (e.g., gas, liquid) that flows through the fluid channel 334 of the attenuator 350, through fluid channel 34 of the sensor port 30, through the fluid channel 44 of the substrate 40, and through the fluid channel 54 of the pressure sensing die 50, wherein the fluid channels 334, 34, 44, 54 are aligned axially, as illustrated by axis 335 of the sensor port fluid channel 34, and form a continuous fluid path. In one embodiment, the fluids channels assume a collinear alignment as shown in FIG. 6.

The attenuator fluid channel 334 comprises an inlet portion 362 and an outlet portion 360, designed as a pressure reduction feature. It should be understood that the tapered cross-section view of FIG. 6 depicts a conical shaped attenuator fluid channel 334 inside attenuator 350 having a sloped sidewall 361. The smaller inlet portion 362 of the attenuator fluid channel 334 faces toward the coupled source of the fluid. A pressure wave in the fluid entering the inlet portion 362 of the attenuator fluid channel 334 and traveling through the larger outlet portion 360 results in a decreased magnitude of the fluid pressure at the front of the wave. The amount of pressure reduction is proportional to the area across the front of the wave. As the pressure wave travels toward the sensor port 30 through the outlet portion 360 the wave front is distributed across an increasingly larger cross-sectional area of the attenuator fluid channel 334, which dissipates the energy of the pressure wave and decreases the magnitude of its pressure. Thus, the pressure wave intensity is gradually reduced as it passes through the outlet portion 360 toward the sensor port fluid channel 34. This provides a lower pressure in the wave entering the sensor port fluid channel 34, and eventually reaching the pressure sensing element 50, than would otherwise occur. The functionality of the pressure sensing element can be affected by pressure spikes impacting the sensor. By reducing the magnitude of pressure waves reaching the sensor, the risk of pressure sensor failure is reduced.

Another embodiment comprises attaching attenuator 350 to the pressure sensing assembly embodiment of FIG. 5, wherein the components of the pressure sensing assembly operate as described above. This embodiment makes use of multiple reduction segments within the continuous fluid channel path to achieve multiple incremental reductions of pressure. In this embodiment, a plurality of incremental pressure reduction regions are employed to reduce the effects of dynamic pressure spikes on the performance of the pressure sensing die. A first stage pressure reduction is contributed by the tapered fluid channel 334 in the attenuator 350, as described above, and a second stage incremental reduction is contributed by the tapered fluid channel 234 in the sensor port 230. The pressure wave magnitude that is gradually reduced as the pressure wave passes through the attenuator outlet portion 360 toward the sensor port fluid channel 234 is again gradually reduced as the pressure wave continues into the sensor port 230 and through the sensor port fluid channel outlet portion 260. This provides an even lower pressure of the wave entering the pressure sensing element 50 than would otherwise occur with a single segment pressure reduction. The functionality of the pressure sensing element can be affected by pressure spikes impacting the sensor. By reducing the magnitude of pressure waves reaching the sensor, the risk of pressure sensor failure is further reduced. Attaching attenuator 350 to the pressure sensing assembly of FIG. 5 provides the same multiple incremental pressure reduction advantages as explained above, due to the tapered fluid channel 234 in the sensor port 230. The functionality of the pressure sensing element can be affected by pressure spikes impacting the sensor. By reducing the magnitude of pressure waves reaching the sensor, the risk of pressure sensor failure is reduced.

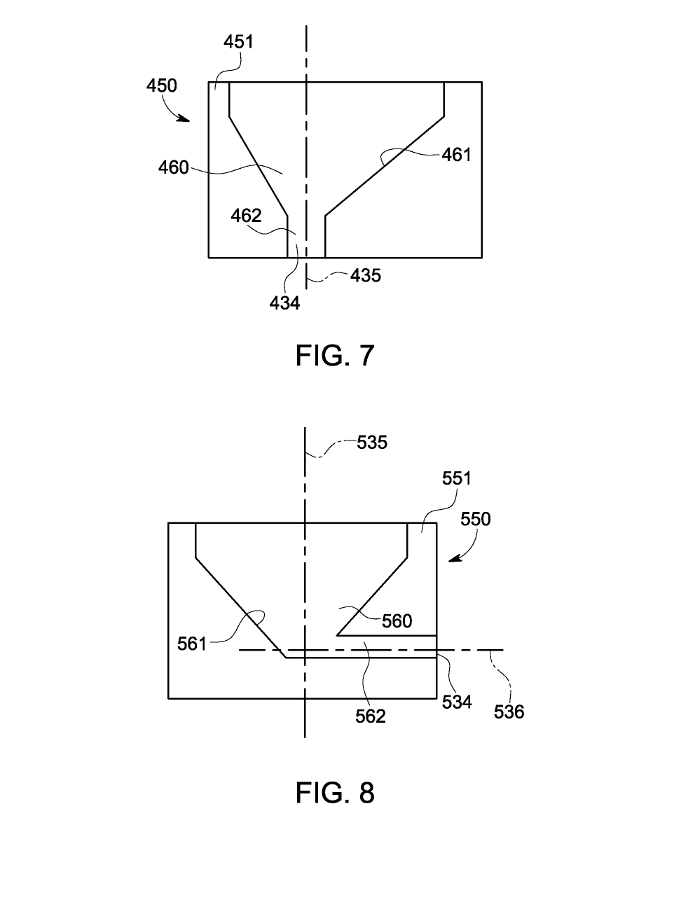

FIG. 7 illustrates another exemplary attenuator 450, which includes a tapered attenuator fluid channel 434 having an inlet portion 462 and an outlet portion 460, that is larger in size than the inlet portion 462, and a rim 451, for attaching the attenuator 450 to the sensor port 230 of FIG. 5 or to the sensor port 30 of FIG. 6. The attenuator fluid channel 434 an inlet portion 462 and an outlet portion 460, designed as a pressure reduction feature. It should be understood that the tapered cross-section view of FIG. 7 depicts an off-axis conical shaped attenuator fluid channel 434 inside attenuator 450 having a sloped sidewall 461. When attached to sensor ports 230 or 30, the axis 435 of the attenuator fluid channel 434 of attenuator 450 is parallel to, and offset from (i.e., not collinear) with, axes 235 and 335 of the sensor port fluid channels 34, 334, respectively. The smaller inlet portion 462 of the attenuator fluid channel 434 faces toward the coupled source of the fluid. A pressure wave in the fluid entering the inlet portion 462 of the attenuator fluid channel 434 and traveling through the larger outlet portion 460 results in a decreased magnitude of the fluid pressure at the front of the wave. The amount of pressure reduction is proportional to the area across the front of the wave. As the pressure wave travels toward the sensor port 230 or 30 through the outlet portion 460 the wave front is distributed across an increasingly larger cross-sectional area of the attenuator fluid channel 434, which dissipates the energy of the pressure wave and decreases the magnitude of its pressure. Thus, the pressure wave intensity is gradually reduced as it passes through the outlet portion 460 toward the sensor port 230 or 30 fluid channel. This provides a lower pressure of the wave entering the sensor port fluid channel 234 or 334, and eventually reaching the pressure sensing element 50, than would otherwise occur. Attaching attenuator 450 to the pressure sensing assembly of FIG. 5 provides the same multiple incremental pressure reduction advantages as explained above, due to the tapered fluid channel 234 in the sensor port 230. The functionality of the pressure sensing element can be affected by pressure spikes impacting the sensor. By reducing the magnitude of pressure waves reaching the sensor, the risk of pressure sensor failure is reduced.

FIG. 8 illustrates another exemplary attenuator 550, which includes a tapered attenuator fluid channel 534 having an inlet portion 562 and an outlet portion 560, that is larger in size than the inlet portion 562, and a rim 551, for attaching the attenuator 550 to the sensor port 230 of FIG. 5 or to the sensor port 30 of FIG. 6. The attenuator fluid channel 534 comprises an inlet portion 562 and an outlet portion 560, designed as a pressure reduction feature. It should be understood that the tapered cross-section view of FIG. 8 depicts a conical shaped outlet portion 560 inside attenuator 550 having a sloped sidewall 561. When attached to sensor ports 230 or 30, the axis 535 of the outlet portion 560 of the attenuator fluid channel 534 is collinear with axes 235 and 335 of the sensor port fluid channels 234, 34, respectively. The axis 536 of the smaller inlet portion 562 of the attenuator fluid channel 534 is approximately perpendicular to axis 535 and, when attached to sensor ports 230 or 30, would also be substantially perpendicular to the axes 235, 335 of their fluid channels 234, 34, respectively. A pressure wave in the fluid traveling toward attenuator 550 will enter the inlet portion 562 of the attenuator fluid channel 534 tangentially, thereby reducing a pressure of the pressure wave traveling through attenuator 550 as compared to the same pressure wave reaching attenuators 350 or 450 as described above. As the wave travels through the larger outlet portion 560 it will result in a decreased magnitude of the fluid pressure at the front of the wave. The amount of pressure reduction is proportional to the area across the front of the wave. As the pressure wave travels toward the sensor port 230 or 30 through the outlet portion 560 the wave front is distributed across an increasingly larger cross-sectional area of the outlet portion 560 of the attenuator fluid channel 434, which dissipates the energy of the pressure wave and decreases the magnitude of its pressure. Thus, the pressure wave intensity is gradually reduced as it passes through the outlet portion 560 toward the fluid channel of sensor port 230 or 30. This provides a lower pressure of the wave entering the sensor port fluid channel 234 or 334 and eventually reaching the pressure sensing element 50 than would otherwise occur. Attaching attenuator 550 to the pressure sensing assembly 200 of FIG. 5 provides the same multiple incremental pressure reduction advantages as explained above, due to the tapered fluid channel 234 in the sensor port 230. The functionality of the pressure sensing element can be affected by pressure spikes impacting the sensor. By reducing the magnitude of pressure waves reaching the sensor, the risk of pressure sensor failure is reduced.

It should be understood that the tapered (conical) shapes illustrated in FIGS. 6, 7, and 8 are examples of a pressure reduction feature of the attenuator fluid channels 334, 434, 534, and that these fluid channels 334, 434, 534 can assume other configurations for reducing the magnitude of a pressure wave. For example, the sidewalls of the attenuator fluid channels 334, 434, 534 can be curved, as in a circular or parabolic arc, or they can comprise steps or points disposed at various angles. All of these configurations should be considered within the scope of the appended claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A pressure sensor assembly for measuring a pressure of a fluid comprising:
a sensor body;
a sensor port coupled to the sensor body and to a source of the fluid, the sensor port comprising a sensor port fluid channel through which the fluid flows from the source of the fluid;
a substrate located in a cavity formed between the sensor body and the sensor port;
a pressure sensing die mounted to the substrate; and
an attenuator coupled to the sensor port, wherein the attenuator comprises an attenuator fluid channel through which the fluid flows from the source of the fluid, the attenuator fluid channel comprising an inlet portion and an outlet portion, the size of the inlet portion is less than the size of the outlet portion, and wherein the sensor port and the attenuator are disposed to form a continuous fluid path through the attenuator fluid channel and the sensor port fluid channel.

2. The pressure sensor assembly of claim 1, wherein the inlet portion comprises an opening of the attenuator fluid channel into which the fluid from the source of the fluid flows.

3. The pressure sensor assembly of claim 1, wherein the attenuator fluid channel and the sensor port fluid channel each comprise an axis along its length, and wherein the attenuator fluid channel axis and the sensor port fluid channel axis are substantially parallel.

4. The pressure sensor assembly of claim 1, wherein the attenuator fluid channel and the sensor port fluid channel each comprise an axis along its length, and wherein the attenuator fluid channel axis and the sensor port fluid channel axis are substantially collinear.

5. The pressure sensor assembly of claim 1, wherein the attenuator fluid channel and the sensor port fluid channel each comprise an axis along its length, and wherein the attenuator fluid channel axis and the sensor port fluid channel axis are offset.

6. The pressure sensor assembly of claim 1, wherein the inlet portion of the attenuator fluid channel and the sensor port fluid channel each comprise an axis along its length, and wherein the axis of the inlet portion of the attenuator fluid channel is approximately perpendicular to the sensor port fluid channel axis.

7. A pressure sensor assembly for measuring a pressure of a fluid comprising:
a sensor body;
a sensor port coupled to the sensor body and to a source of the fluid, the sensor port comprising a sensor port fluid channel through which the fluid flows from the source of the fluid, the sensor port fluid channel comprising a port inlet portion and a port outlet portion, wherein the size of the port inlet portion is less than the size of the port outlet portion;
a substrate located in a cavity formed between the sensor body and the sensor port;
a pressure sensing die mounted to the substrate; and
an attenuator coupled to the sensor port, wherein the attenuator comprises an attenuator fluid channel through which the fluid flows from the source of the fluid, the attenuator fluid channel comprising an attenuator inlet portion and an attenuator outlet portion, the size of the attenuator inlet portion is less than the size of the attenuator outlet portion, and wherein the sensor port and the attenuator are disposed to form a continuous fluid path through the attenuator fluid channel and the sensor port fluid channel.

8. The pressure sensor assembly of claim 7, wherein the port inlet portion comprises an opening of the sensor port fluid channel into which the fluid from the source of the fluid flows.

9. The pressure sensor assembly of claim 7, wherein the attenuator fluid channel and the sensor port fluid channel each comprise an axis along its length, and wherein the attenuator fluid channel axis and the sensor port fluid channel axis are substantially parallel.

10. The pressure sensor assembly of claim 7, wherein the attenuator fluid channel and the sensor port fluid channel each comprise an axis along its length, and wherein the attenuator fluid channel axis and the sensor port fluid channel axis are substantially collinear.

11. The pressure sensor assembly of claim 7, wherein the attenuator fluid channel and the sensor port fluid channel each comprise an axis along its length, and wherein the attenuator fluid channel axis and the sensor port fluid channel axis are offset.

12. The pressure sensor assembly of claim 7, wherein the inlet portion of the attenuator fluid channel and the sensor port fluid channel each comprise an axis along its length, and wherein the axis of the inlet portion of the attenuator fluid channel is approximately perpendicular to the sensor port fluid channel axis.

13. A pressure sensor assembly for measuring a pressure of a fluid comprising:
a sensor body;
a sensor port coupled to the sensor body and to a source of the fluid, the sensor port comprising a sensor port fluid channel through which the fluid flows from the source of the fluid, the sensor port fluid channel comprising a port inlet portion and a port outlet portion, wherein the size of the port inlet portion is less than the size of the port outlet portion;
a substrate located in a cavity, the cavity formed between the sensor body and the sensor port; and
a pressure sensing die mounted to the substrate.

14. The pressure sensor assembly of claim 13, wherein the substrate further comprises a substrate fluid channel through which the fluid flows from the source of the fluid, the pressure sensing die further comprises a die fluid channel through which the fluid flows from the source of the fluid, and wherein the substrate, the pressure sensing die, and the sensor port are disposed to form a continuous fluid path through the sensor port fluid channel, the substrate fluid channel and the die fluid channel.
